(19) United States
(12) Patent Application Publication
(10) Pub. No.: US 2006/0176876 A1
(43) Pub. Date: Aug. 10, 2006

(54) Telephone system

(76) Inventors: Justin A. Aborn, Hingham, MA (US); Sanjay S. Jhawar, Chicago, IL (US)

Correspondence Address: FISH & RICHARDSON PC, P.O. BOX 1022, MINNEAPOLIS, MN, 55440-1022, US

(21) Appl. No.: 11/347,437

(22) Filed: Feb. 3, 2006

Related U.S. Application Data
(60) Provisional application No. 60/649,939, filed on Feb. 4, 2005.

(51) Int. Cl. H04L 12/66

(52) U.S. Cl. 370/352

(57) ABSTRACT

A communication system includes a subsystem that provides an interface between an IP based telephone control network and a public data network, the subsystem is used for registration of a subscriber's devices on the public data network with the telephone network and enables receiving and/or originating communication sessions from the devices through the telephone network. The subsystem can emulate a P-CSCF function to couple devices on the public Internet, for example voice-over-IP devices, to an IMS or MMD cellular telephone infrastructure.

### CROSS-REFERENCE TO RELATED APPLICATIONS

This application claims the benefit of U.S. Provisional Application No. 60/649,939, filed Feb. 4, 2005, which is incorporated by reference.

This application is also related to U.S. application Ser. No. 10/463,111 “Circuit Switched Cellular Network to Internet Calling with Internet Antennas”, filed Jun. 16, 2003, published as Pub. 2003/0224795A1, U.S. application Ser. No. 11/183,534, “Handoff for Cellular and Internet Protocol Telephony”, filed Jul. 18, 2005, and International Application No. PCT/US2005/025353, “Presence Detection and Handoff for Cellular and Internet Protocol Telephony”, filed Jul. 18, 2005, all of which are incorporated herein by reference.

### BACKGROUND

This invention relates to a telephone system.

The IP Multimedia Subsystem (IMS) provides an approach to delivering IP based services, for example, through cellular telephone networks. Referring to FIG. 1, an IMS network 100 implements a number of functions that enable a subscriber to access IMS services from a representative user device 110, such as from a mobile telephone with data capabilities. The user device accesses the IMS functions and services via a cellular data access network 120, such as a CDMA2000 or a GPRS based access network. Within the IMS network, the subscriber accesses the services using a Call State Control Function (CSCF) 130 of the network. A subscriber registers with the CSCF, for example, when the subscriber enters the cellular network. The CSCF queries a Home Subscriber Server (HSS) 150, which includes IMS data 152 that includes information identifying services available to the subscriber. When the CSCF receives the information from the HSS identifying the services available to the subscriber, the CSCF communicates with IMS services 140, which can include multiple individual applications 142. The applications communicate via the cellular data access network 120 with the subscriber's device 110, and may communicate with the HSS to access application-specific data associated with the subscriber. The application may access external networks, such as IP networks 180.

The functionality of the CSCF 130 is distributed among a Proxy CSCF function (P-CSCF) 136, and Interrogating CSCF function (I-CSCF) 134, and a Serving CSCF function (S-CSCF) 132. There may be additional P-CSCF functions 136 that communicate with the I-CSCF and the S-CSCF, for example, when the subscriber enters a foreign data access network (e.g., in another country). A P-CSCF associated with that other data access network provides a link for control information with the S-CSCF associated with the subscriber.

A circuit switched (CS) internetworking function 160 can provide a media gateway 164 to pass audio between the public switched telephone network or the public land mobile network (PSTN/PLMN) 170 and the cellular data access network. Signaling information, for example from a Signaling System 7 (SS7) network 172 associated with the PSTN/PLMN 170, passes through a media gateway control function (MGCF) 162 to the cellular data access network 120.

Control information in the IMS network uses a version of the Session Initiation Protocol (SIP), for example, between the user device 110 and the CSCF 130, and among the CSCF 130, HSS 150, CS Internetworking function 160, and the IMS services 140. Data passing between the application 142 and the user device 110 make use of application-specific protocols layered on the Internet Protocol (IP) network, generally using the same network as the SIP control traffic.

Other approaches that are similar to IMS is also being proposed. For example, an approach called Multi-Media Domain (MMD) has been proposed for CMDA networks.

### SUMMARY

In one aspect, in general, a communication system includes a subsystem that provides an interface between an IP based telephone control network and a public data network, the subsystem is used for registration of a subscriber's devices on the public data network with the telephone network and enables receiving and/or originating communication sessions from the devices through the telephone network.

Aspects can include one or more of the following.

The telephone control network includes a control network for acellular telephone system.

The telephone control network includes an IMS or an MMD infrastructure.

The subsystem includes a component that emulates a P-CSCF.

The communication sessions include VoIP telephone sessions.

The public data network includes a public Internet.

The public data network includes a wireless local area network.

The subsystem provides adaptations communication protocols used on the public data network and the telephone control network. For instance, the subsystem provides adaptations between IETF and IMS protocols, such as between IETF and IMS SIP protocols.

In another aspect, in general, a method for providing telephone services includes maintaining presence in a telephone network for devices on a public data network. Calls directed to a subscriber are delivered through the telephone network to the devices on the public data network.

Aspects can include one or more of the following.

The telephone network includes a wireless telephone network.

The telephone network includes a packet switched control infrastructure.

The telephone network includes an IP-based control infrastructure.

The telephone network includes an IMS or an MMD infrastructure.

The public data network includes a packet switched network, such as the public Internet, or a wireless local area network.

In another aspect, in general, a method for communication includes providing and IP-based connection, such as a VoIP connection, to a subscriber's device resident on a public data network via an IMS or MMD framework.

The method may include emulating an edge function of the IMS or MMD framework. For example, a P-CSCF function is emulated.

In another aspect, in general, a communication system includes a subsystem for enabling packet-based telephone connections of calls placed to a wireless telephone network. The subsystem includes an interface to components of the telephone network used to complete circuit-based telephone connections, an interface to components of the telephone network used to provide data network based services, and an interface to a public data network.

In another aspect, in general, a method for communication includes providing a service in a telephone network configured to deliver data services. The service enables determining a first set of end devices in a wireless network, determining a second set of end devices in a wireline network, associating the first set of end devices and the second set of end devices, receiving a call for one associated device, and notifying the call to all associated devices. The telephone network may be configured to deliver data services in an IMS or a MMD network.

Aspects can have one or more of the following advantages.

SIP devices that implement User Agents on a public Internet can participate in the IMS network without implementing all required IMS functions by providing adaptation, for example, the VoIP proxy CSCF function that bridges the IMS network and the public Internet.

Configuration and provisioning of services may be easier when information regarding the subscriber's services can be centralized in the HSS rather than being distributed between the HLR and a subscriber database that is separately provisioned for a network gateway.

Other aspects, features, and advantages are apparent from the following description and from the claims.

### DESCRIPTION OF DRAWINGS

FIG. 1 is a block diagram of an IP Multimedia Subsystem (IMS) based system.

FIG. 2 is a block diagram of a communication system that includes a network gateway for passing voice-over-IP (VoIP) communication via a broadband network.

FIG. 3 is a block diagram of a communication system that uses IMS functions to pass VoIP communication via a broadband network.

### DESCRIPTION

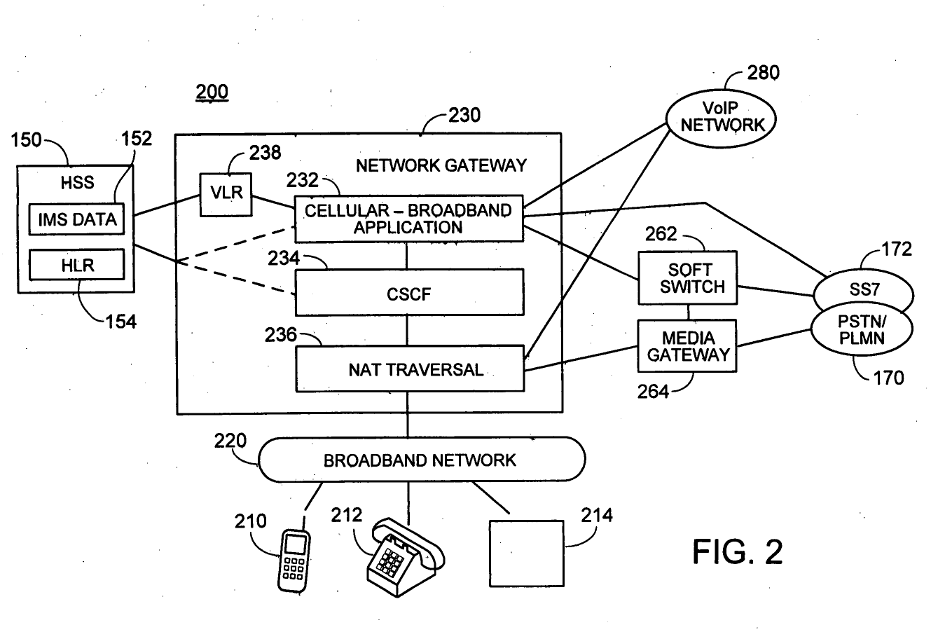

Referring to FIG. 2, a first communication system 200 provides a Voice over Internet Protocol (VoIP) service to devices using certain functions of an IMS network. In particular, the system includes a network gateway 230 that implements functionality that enables delivery of telephone calls that are directed to a telephone number associated with a subscriber's cellular telephone. The call is converted into a VoIP call and delivered over a broadband IP-based data network 220 (e.g., over the public Internet or a private IP network such as a cable-television based IP network) to the subscribers phone 210, for example, in the case of the phone being a dual mode phone providing cellular and WiFi connectivity, or to another device providing the functionality of a VoIP telephone (e.g., IP phone 212, IP Centrex 214, etc.).

In general, calls are delivered over the broadband network 220 if the subscriber's IP device 210-216 is registered with the system and the-cellular system's Home Location Register (HLR) function 154 (which is incorporated in the HSS function 150 of the IMS network) is informed that the subscriber is registered in the broadband network. When the cellular system receives a call for the subscriber, for example from public switched telephone network (PSTN), when the subscriber's device is registered-over the broadband network, control information passes between the HLR and a Visitor Location Register (VLR) function 238 of the network gateway 230 such that the call is directed to a temporary number at a media gateway 264. A soft switch 262 receives control information for the inbound call and controls the media gateway 264 and informs the cellular-broadband application 232 to direct the circuit switch call as a VoIP call to the subscriber's VoIP device. Ways of directing the call to the media gateway rather than or in addition to the user's circuit switched phone are described in the incorporated application Ser. No. 11/183,534, and PCT/US 2005/025353.

The network gateway 230 includes a cellular-broadband application 232, which includes a SIP server function that makes use of a subscriber database at HSS 150 that includes information regarding addresses of the subscriber's IP devices, and other configuration information. Information regarding registration of the subscriber's IP-based devices, permissions, routing policies, etc. is stored in the HSS in association with the VoIP service provided by the network gateway. Note that the cellular telephone network HLR function alone is not generally flexible enough to host such subscriber information, whereas the HSS function provides for storing additional sorts of application-specific information.

The network gateway 230 implements an IMS call state control function (CSCF) 234. This function provides an IMS interface to the HSS 150. The CSCF optionally also handles registration of user devices 210-214, for example, using IMS compliant techniques for the interchange between the user device and the CSCF function. When a user device registers with the network gateway 230, the CSCF informs the application 232, which updates the VLR function 238, which in turn updates the HLR 154 in the HSS 150 to indicate that the user is registered in the broadband domain. The CSCF 234 may also communicate directly with the HSS 150 in order to store additional information related to the user's registration if such information is not representable or easily represented using standard HLR/VLR functionality.

The network gateway 230 can also include a network access component, such as a Network Address Translation (NAT) Traversal component 236, which provides access over the broadband network 220 and handles any necessary processing to provide a data path between the application 232 and the user device 210-214,-for example, if the user device is on a private local network for which network address translation is performed by an edge device of that private network.

Outbound calls are handled similarly, with SIP-based control information passing from the user device to the application 232. The application then sends control information to the soft switch 262, which in turn controls the media gateway 264 and provides control information to the SS7 network 172 to place the outbound call. The application 232 controls NAT traversal component 220 to direct the VoIP call to the media gateway 264.

The network gateway 230 also provides a way of coupling a VoIP network 280 with user devices 210-214. For example, the application 232 can receive SIP requests to establish sessions with the user devices, and set up a data path for the session from the VoIP network 280 to the NAT traversal component 236. Similarly, the application 232 can establish SIP sessions to the VoIP network that are initiated from the user devices. The VoIP network can include a number of SIP servers and SIP endpoints that are resident on the public Internet, or alternatively, may be a private network in which SIP is used.

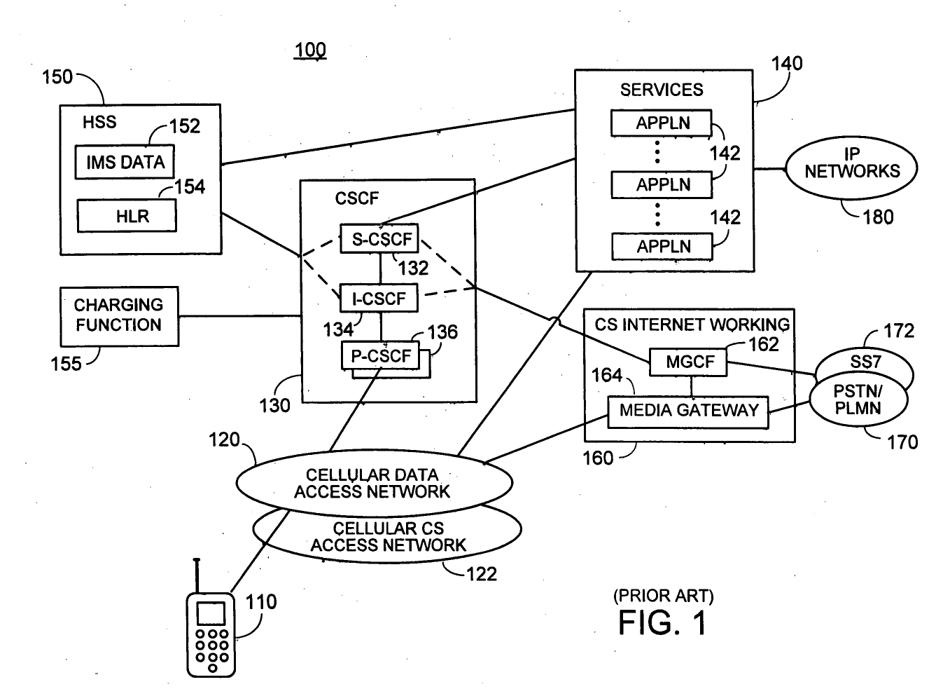

A variant of the system shown in FIG. 2 enables user devices to access services 140 (see FIG. 1) via the S-CSCF function of the CSCF 234 of the network gateway 230. In this version of the system, the functionality of a P-CSCF, and an I-CSCF and an S-CSCF remains integrated in the network gateway 230, which provides VoIP-based services to the subscriber's IP devices. The IMS services access the S-CSCF function, for example, to establish a connection to the subscriber's devices. The S-CSCF function also provides access to the HSS, which hold subscriber information as in the previously described version of the system.

Another variant of the system shown in FIG. 2 makes use of a CS internetworking function 160 (see FIG. 1) instead of or in addition to the media gateway 264 and soft switch 262. The CS internetworking function 160 interchanges control information with the S-CSCF function of the CSCF 234 of the network gateway 230 in order to establish calls received through the IMS CS Internetworking components. Note that versions of the system can include portions of this embodiment as well as the previous embodiment, such that calls may be established both though the standard IMS CS Internetworking components 160 as well as through a media gateway 264 dedicated to the network gateway 230.

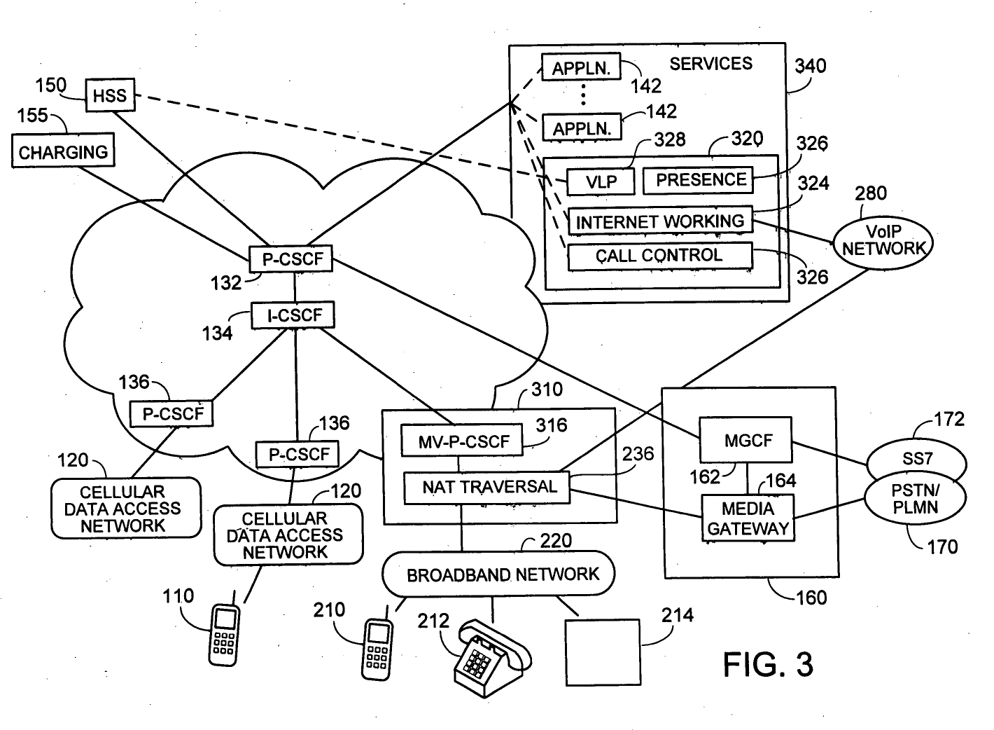

Referring to FIG. 3, in a second communication system, the capabilities of the network gateway 230, shown in FIG. 2 is distributed between an application 320 in IMS services 340 and a component 310 that provides a bridge between the IMS IP and SIP-based network and the broadband network 220, which also uses IP and SIP. The application 320 provides functionality of a VLR and the call control components needed to provide the functionality of the networking gateway.

When the subscriber's cellular device 110 registers with the P-CSCF 136 associated with the cellular data access network 120, the P-CSCF communicates with the I-CSCF 134 and S-CSCF 132 using conventional IMS based approaches. The S-CSCF uses the identity of the P-CSCF through which the subscriber is accessing the network to determine the services available to the subscriber as stored in the HSS 150. For instance, termination of VoIP calls may not be available to the subscriber, while IP services such as IP-based push-to-talk, video streaming, etc. may be available to the subscriber through applications 142.

When a subscriber joins broadband network 220, for example, by reaching his home or office and establishing a presence on a WiFi network that is coupled to a broadband network the subscriber's IP device can establish a presence on the IMS network the presence function 326 may be integrated in the application 320 of the IMS services 340. A MobileVoIP P-CSCF (MV-P-CSCF) 316 component couples the broadband network (e.g., the public Internet) to which the subscriber's IP devices 210-214 (e.g., IETF compliant SIP phones, “soft phone” and the like) to the IMS IP-based control network, which also hosts standard S-CSCF and I-CSCF functions. That is, the MV-P-CSCF 316 participates in the IMS network according to the IMS IP control protocols. The MV-P-CSCF 316 acts as a peer to the P-CSCF 136 though which the subscriber's cellular telephone accesses the IMS system. The subscriber's IP devices' register and other request services through the MV-P-CSCF in essentially the same manner as the cellular devices accesses services, i.e., through the S-CSCF 132 based on configuration information from the HSS 150. When a subscriber's IP device registers, for example, because a subscriber's dual mode phone is detected on a WiFi network coupled to the MV-P-CSCF 316 registration information passes through the S-CSCF 132 and/or the I-CSCF 134 to the HSS 150. Based on the P-CSCF (in this case the MV-P-CSCF), the S-CSCF may provide access to services such as the MobileVoIP service that enables calls to be delivered to the subscriber's public network resident IP devices when a call is placed to the subscriber's mobile telephone number. Components of the MobileVoIP application server can be configured to prevent the IP devices from registering on the telephone network if the subscriber's cellular phone is concurrently registered through another P-CSCF.

As introduced above, the component 310 includes the MV-P-CSCF 316 which provides an interface for control (i.e. SIP) and the NAT traversal component 236 which provides an interface for packet voice data paths (i.e. RTP). For control paths, the MV-P-CSCF 316 optionally provides an adaptation of IETF SIP protocols that are used on the broadband (public) network and the IMS SIP protocols, which are somewhat different from the SIP protocol used within the IMS network. For example, this adaptation allows the subscriber's SIP devices to implement User Agents that do not implement extensions required by the IMS SIP protocols.

The component 310 also provides a gateway for VoIP data traffic between the private network of the telephone system and the public broadband network on which the subscriber's IP devices reside. Note that this gateway function and the control data adaptation functions do not necessarily reside in the same physical device, or at the same geographic location.

In alternative versions of the system, the media gateway 164 is not necessarily integrated into a standard component 160 of the IMS architecture. For example, a dedicated media gateway 264 and a soft switch 262, as shown in FIG. 2, can be used.

The application 320 also includes an internetworking component 324, which provides a link to other VoIP networks 280. For example, the internetworking component can act as a SIP server, and receive requests to connect sessions to user devices 210-214. Based on the registration information the application 320 receives from the S-CSCF 132 and from the HSS 150, the internetworking component establishes a data path from the VoIP network 280 to the NAT traversal component 236. Similarly, the internetworking component 326 passes SIP messages between a user device and the VoIP network in order to establish sessions initiated from the user devices.

Although described above predominantly in the context of call delivery when a call is placed to the subscriber's cellular telephone number, functions such as call origination at the subscriber's IP devices, as well as handoff between the broadband IP domain and the cellular domain are supported by versions of the system including at least some of the versions described above. For example, for handoff between a circuit switched call to user's dual mode handset and an IP-based call to the handset over the broadband network, the system may establish a SIP session between the user's device and a component of the cellular system that is handling the circuit switched call. This component can then hand off the call between the circuit path and the VoIP path to the user's device.

In some implementations, the component 310 and the application 320 components are integrated into a single device and/or hosted at a common location. In other implementations they are separate, and may be operated by different entities, for example one by a telephone service provider and one by a broadband network (e.g., cable TV) provider. More generally, various functions and components described above are not necessarily hosted in different devices or at different geographic locations in the network, and particular functions or components may be distributed.

The approaches described above for use in IMS networks are equally applicable to other network architectures such as to CMDA networks that implement the MMD architecture.

Other embodiments are within the scope of the following claims.

What is claimed is:

1. A communication system comprising:
a subsystem that provides an interface between an IP based telephone control network and a public data network, the subsystem being used for registration of a subscriber's devices on the public data network with the telephone network and enabling receiving and/or originating communication sessions from the devices through the telephone network.

2. The system of claim 1 wherein the telephone control network includes a control network for a cellular telephone system.

3. The system of claim 1 wherein the telephone-control network includes an IMS or an MMD infrastructure.

4. The system of claim 3 wherein the subsystem includes a component that emulates a P-CSCF.

5. The system of claim 1 wherein the communication sessions include VoIP telephone sessions.

6. The system of claim 1 wherein the public data network includes a public Internet.

7. The system of claim 1 wherein the public data network includes a wireless local area network.

8. The system of claim 1 wherein the subsystem provides adaptations communication protocols used on the public data network and the telephone control network.

9. The system of claim 8 wherein the subsystem provides adaptations between IETF and IMS protocols.

10. The system of claim 9 wherein the subsystem provides adaptation between IETF and IMS SIP protocols.

11. A method for providing telephone services comprising:
maintain presence in a telephone network for devices on a public data network; and
delivering calls directed to a subscriber through the telephone network to the devices on the public data network.

12. The method of claim 11 wherein the telephone network includes a wireless telephone network.

13. The method of claim 11 wherein the telephone network includes a packet switched control infrastructure.

14. The method of claim 11 wherein the telephone network includes an IP-based control infrastructure.

15. The method of claim 11 wherein the telephone network includes an IMS or an MMD infrastructure.

16. The method of claim 11 wherein the public data network includes a packet switched network.

17. The method of claim 16 wherein the packet switched network includes a public Internet.

18. The method of claim 16 wherein the packet switched network includes a wireless local area network.

19. A method for communication comprising:
providing and IP-based connection to a subscriber's device resident on a public data network via an IMS or MMD framework.

20. The method of claim 19 wherein providing the IP-based connection to the subscriber's device include providing a VoIP connection.

21. The method of claim 19 further comprising emulating an edge function of the IMS or MMD framework.

22. The method of claim 21 wherein emulating the edge device include emulating a P-CSCF function.

23. A communication system comprising:
a subsystem for enabling packet based telephone connections of calls placed to a wireless telephone network, the subsystem including
(a) an interface to components of the telephone network used to complete circuit-based telephone connections,
(b) an interface to components of the telephone network used to provide data network based services, and
(c) an interface to a public data network.

24. A method for communication comprising:
providing a service in a telephone network configured to deliver data services,
said service enabling
determining a first set of end devices in a wireless network,
determining a second set of end devices in a wireline network,
associating the first set of end devices and the second set of end devices,
receiving a call for one associated device, and
notifying the call to all associated devices.

25. The method of claim 24 wherein the telephone network is configured to deliver data services in an IMS or a MMD network
